(19) United States
(12) Patent Application Publication
(10) Pub. No.: US 2017/0046123 A1
(43) Pub. Date: Feb. 16, 2017

(54) DEVICE FOR PROVIDING SOUND USER INTERFACE AND METHOD THEREOF

(71) Applicant: Samsung Electronics Co., Ltd., Gyeonggi-do (KR)

(72) Inventors: Ji Tae SONG, Gyeonggi-do (KR); Seong Hwan KIM, Gyeonggi-do (KR); Jung Won MOON, Seoul (KR); Sang Hee PARK, Gyeonggi-do (KR); Ji Hyuk YU, Gyeonggi-do (KR); Jung Won LEE, Incheon (KR); Jong Wook LIM, Gyeonggi-do (KR); Jung Eun LEE, Gyeonggi-do (KR)

(73) Assignee: Samsung Electronics Co., Ltd.

(21) Appl. No.: 15/235,766

(22) Filed: Aug. 12, 2016

(30) Foreign Application Priority Data
Aug. 12, 2015 (KR) 10-2015-0113724

(51) Int. Cl. G06F 3/16; H04S 7/00; G06F 3/01; G06F 3/0486

(52) U.S. Cl. CPC G06F 3/167; G06F 3/0486; H04S 7/30; G06F 3/165; G06F 3/013

(57) ABSTRACT

An electronic device and method for providing sound user interface is provided. The electronic device includes a display circuit configured to display at least one object, an audio circuit configured to reproduce sound, and a processor electrically connected to the display circuit and the audio circuit. The processor is configured to configure virtual space coordinates for the at least one object, match a sound source to the at least one object, set a sound effect for the sound source based on the virtual space coordinates, and reproduce the sound source using the set sound effect.

### PRIORITY

This application claims priority under 35 U.S.C. §119(a) to Korean Patent Application Serial No. 10-2015-0113724 which was filed on Aug. 12, 2015, in the Korean Intellectual Property Office, the entire disclosure of which is incorporated herein by reference.

### BACKGROUND

1. Field of the Disclosure

The present disclosure relates to an electronic device, and more particularly, to a device and method for providing a sound user interface in an electronic device.

2. Description of the Related Art

With the recent development of information communication technology, a network device such as a base station allows a user to use a network anywhere by transmitting/receiving data to/from another electronic device through the network.

Electronic devices provide various functions according to recent digital convergence trends. For example, in addition to phone calls, smartphones support Internet access functions by using the network, music or video playback functions, and picture or video capturing functions by using an image sensor.

Furthermore, in order for electronic devices to provide convenient functions to users effectively, various user interface (UI) techniques are developed. As a representative example, a graphic user interface (GUI) displayed on the screen of an electronic device may be provided.

### SUMMARY

Accordingly, an aspect of the present disclosure is to provide an electronic device and method for providing sound in order to allow a user to feel as if a sound source on an object displayed on a screen was played in an intended space.

In accordance with an aspect of the present disclosure, an electronic device includes a display circuit configured to display at least one object, an audio circuit configured to reproduce sound, and a processor electrically connected to the display circuit and the audio circuit, wherein the processor is configured to generate virtual space coordinates for the at least one object, match a sound source to the at least object, set a sound effect for the sound source based on the virtual space coordinates, and reproduce the sound source using the set sound effect.

In accordance with another aspect of the present disclosure, a method of an electronic device includes displaying an object, generating virtual space coordinates for the object, matching a sound source to the object, setting a sound effect for the sound source based on the virtual space coordinates, and reproducing the sound source where the sound effect is set.

In accordance with another aspect of the present disclosure, an electronic device includes a memory configured to store a plurality of specified positions where an object corresponding to a sound source is to be displayed through a display functionally connected to the electronic device, wherein the plurality of specified positions include a first specified position and a second specified position, and at least one processor, wherein the at least one processor is configured to display the first specified position and the second specified position in relation to the object through the display, receive an input relating to the object, and move the object from the first specified position to the second specified position in response to the input and output the sound source in a state of a changed sound effect of the sound source based on a traveling distance or a direction of the object from the first specified position to a point between the first specified position and the second specified position.

### BRIEF DESCRIPTION OF THE DRAWINGS

The above and other aspects, advantages, and salient features of the present disclosure will become more apparent to those skilled in the art from the following detailed description taken in conjunction with the accompanying drawings, in which:

FIG. 1 illustrates an electronic device in a network environment according to an embodiment of the present disclosure;

FIG. 2 is a block diagram of an electronic device according to an embodiment of the present disclosure;

FIG. 3 is a block diagram illustrating a program module according to an embodiment of the present disclosure;

FIG. 4 is a block diagram of an electronic device for providing a user interface (UI) according to an embodiment of the present disclosure;

FIG. 5A illustrates a user holding an electronic device and its coordinate system according to an embodiment of the present disclosure;

FIG. 5B illustrates a virtual space coordinate conversion applied to an object shown on an electronic device according to an embodiment of the present disclosure;

FIG. 5C illustrates a virtual space coordinate conversion applied to an object shown on an electronic device according to an embodiment of the present disclosure;

FIG. 6A illustrates a user's gaze looking down at an electronic device according to an embodiment of the present disclosure;

FIG. 6B illustrates a virtual space created based on a user's gaze of an electronic device according to an embodiment of the present disclosure;

FIG. 7 illustrates a virtual space coordinate conversion applied to a keypad object according to an embodiment of the present disclosure;

FIG. 8 illustrates a virtual space coordinate conversion applied to a canvas object according to an embodiment of the present disclosure;

FIG. 9A illustrates a music listening application where an album cover image object is displayed according to an embodiment of the present disclosure;

FIG. 9B illustrates a virtual space coordinate conversion applied to an album cover image object according to an embodiment of the present disclosure;

FIG. 9C illustrates an operation for applying a user input received from a user on a music listening application where an album cover image object is displayed according to an embodiment of the present disclosure;

FIG. 9D illustrates a virtual space coordinate conversion applied to an album cover image object based on a user input according to an embodiment of the present disclosure;

FIG. 10 illustrates a music listening application where an album cover image object is displayed according to another embodiment of the present disclosure;

FIG. 11 illustrates a music listening application where an album cover image object is displayed according to another embodiment of the present disclosure;

FIG. 12 is a flowchart illustrating a method of an electronic device to provide a sound UI according to an embodiment of the present disclosure; and

FIG. 13 is a flowchart illustrating a method of an electronic device to provide a sound UI in correspondence to a three-dimensional object according to an embodiment of the present disclosure.

### DETAILED DESCRIPTION

Hereinafter, various embodiments of the present disclosure are disclosed with reference to the accompanying drawings. However, the present disclosure is not limited by the various embodiments of the present disclosure to a specific embodiment and it is intended that the present disclosure covers all modifications, equivalents, and/or alternatives of the present disclosure within the scope of the appended claims and their equivalents. With respect to the descriptions of the accompanying drawings, like reference numerals refer to like elements.

The terms and words used in the following description and claims are not limited to their dictionary meanings, but, are merely used to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms “include,” “comprise,” and “have”, or “may include,” or “may comprise” and “may have” as used herein indicate disclosed functions, operations, or existence of elements but do not exclude other functions, operations or elements.

For example, the expressions “A or B,” or “at least one of A and/or B” may indicate A and B, A, or B. For instance, the expression “A or B” or “at least one of A and/or B” may indicate (1) at least one A, (2) at least one B, or (3) both at least one A and at least one B.

The terms “1st,” “2nd,” “first,” “second,” and the like used herein may refer to modifying various different elements of various embodiments of the present disclosure, but do not limit the elements. For instance, “a first user device” and “a second user device” may indicate different user devices regardless of order or importance. For example, a first component may be referred to as a second component and vice versa without departing from the scope and spirit of the present disclosure.

According to an embodiment of the present disclosure, it is intended that when a component (for example, a first component) is referred to as being “operatively or communicatively coupled with/to” or “connected to” another component (for example, a second component), the component may be directly connected to the other component or connected through another component (for example, a third component). It is intended that when a component (for example, a first component) is referred to as being “directly connected to” or “directly accessed” another component (for example, a second component), another component (for example, a third component) does not exist between the component (for example, the first component) and the other component (for example, the second component).

The expression “configured to” may be interchangeably used with “suitable for,” “having the capacity to,” “designed to,” “adapted to,” “made to,” or “capable of” according to the situation, for example. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (for example, an embedded processor) for performing a corresponding operation or a general purpose processor (for example, a central processing unit (CPU) or application processor (AP)) for performing corresponding operations by executing at least one software program stored in a memory device.

Terms used in the present disclosure do not limit the scope of the embodiments. The terms of a singular form may include plural forms unless they have a clearly different meaning in the context. Otherwise, all terms used herein may have the same meanings that are generally understood by a person skilled in the art. In general, terms defined in a dictionary should be considered to have the same meanings as the contextual meaning of the related art, and, unless clearly defined herein, should not be understood differently or as having an excessively formal meaning. The terms defined in the present specification are not intended to be interpreted as excluding embodiments of the present disclosure.

An electronic device according to an embodiment of the present disclosure may include at least one of a smartphone, a tablet personal computer (PC), a mobile phone, a video telephone, an electronic book reader, a desktop PC, a laptop PC, a netbook computer, a workstation, a server, a personal digital assistant (PDA), a portable multimedia player (PMP), a motion picture experts group (MPEG-1 or MPEG-2) audio layer 3 (MP3) player, a mobile medical device, a camera, or a wearable device. The wearable device may include at least one of an accessory-type device (e.g., a watch, a ring, a bracelet, an anklet, a necklace, eyeglasses, contact lens, a head-mounted device (HMD)), a textile- or clothing-integrated-type device (e.g., an electronic apparel), a body-attached-type device (e.g., a skin pad or a tattoo), or a bio-implantable-type device (e.g., an implantable circuit)

According to an embodiment of the present disclosure, an electronic device may be a home appliance. The smart home appliance may include at least one of, for example, a television (TV), a digital video/versatile disc (DVD) player, an audio player, a refrigerator, an air conditioner, a cleaner, an oven, a microwave oven, a washing machine, an air cleaner, a set-top box, a home automation control panel, a security control panel, a television (TV) box (e.g., Samsung HomeSync™, Apple TV™, or Google TV™), a game console (e.g., Xbox™ or PlayStation™), an electronic dictionary, an electronic key, a camcorder, or an electronic picture frame

According to an embodiment of the present disclosure, an electronic device may include at least one of various medical devices (e.g., various portable medical measurement devices (e.g., a blood glucose measuring device, a heart rate measuring device, a blood pressure measuring device, a body temperature measuring device, and the like), a magnetic resonance angiography (MRA), a magnetic resonance imaging (MRI), a computed tomography (CT), a scanner, an ultrasonic device, and the like), a navigation device, a global navigation satellite system (GNSS), an event data recorder (EDR), a flight data recorder (FDR), a vehicle infotainment device, electronic equipment for vessels (e.g., a navigation system, a gyrocompass, and the like), avionics, a security device, a head unit for a vehicle, an industrial or home robot, an automatic teller machine (ATM), a point of sales (POS) terminal, or an Internet of Things (IoT) device (e.g., a light bulb, various sensors, an electric or gas meter, a sprinkler, a fire alarm, a thermostat, a streetlamp, a toaster, exercise equipment, a hot water tank, a heater, a boiler, and the like).

According to an embodiment of the present disclosure, an electronic device may include at least one of a part of furniture or a building/structure, an electronic board, an electronic signature receiving device, a projector, or a measuring instrument (e.g., a water meter, an electricity meter, a gas meter, a wave meter, and the like). An electronic device may be one or more combinations of the above-mentioned devices. An electronic device may be a flexible device. An electronic device is not limited to the above-mentioned devices, and may include new electronic devices with the development of new technology.

Hereinafter, an electronic device according to various embodiments of the present disclosure will be described in more detail with reference to the accompanying drawings. The term “user” as used herein may refer to a person who uses an electronic device or may refer to a device (e.g., an artificial intelligence electronic device) that uses an electronic device.

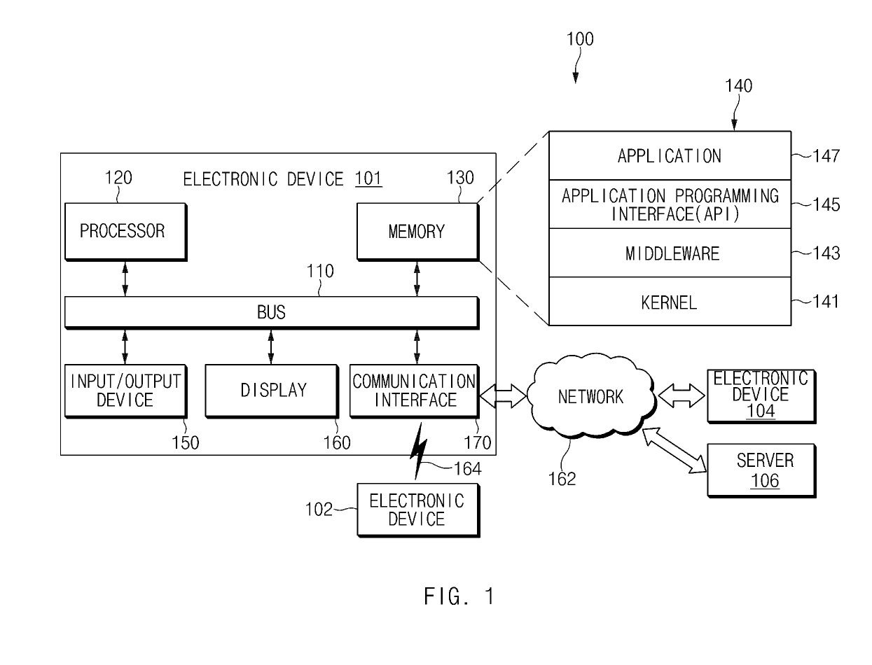

FIG. 1 illustrates an electronic device in a network environment according to an embodiment of the present disclosure. An electronic device 100 in a network environment 100 will be described with reference to FIG. 1. The electronic device 100 includes a bus 110, a processor 120, a memory 130, an input/output interface 150, a display 160, and a communication interface 170. At least one of the foregoing elements may be omitted or another element may be added to the electronic device 100.

The bus 110 may include a circuit for connecting the above-mentioned elements 110 to 170 to each other and transferring communications (e.g., control messages and/or data) among the above-mentioned elements.

The processor 120 may include at least one of a central processing unit (CPU), an application processor (AP), or a communication processor (CP). The processor 120 may perform data processing or an operation related to communication and/or control of at least one of the other elements of the electronic device 100.

The memory 130 may include a volatile memory and/or a nonvolatile memory. The memory 130 may store instructions or data related to at least one of the other elements of the electronic device 100. According to an embodiment of the present disclosure, the memory 130 may store software and/or a program 140. The program 140 includes, for example, a kernel 141, a middleware 143, an application programming interface (API) 145, and/or an application program (or an application) 147. At least a portion of the kernel 141, the middleware 143, or the API 145 may be referred to as an operating system (OS).

The kernel 141 may control or manage system resources (e.g., the bus 110, the processor 120, the memory 130, and the like) used to perform operations or functions of other programs (e.g., the middleware 143, the API 145, or the application 147). Furthermore, the kernel 141 may provide an interface for allowing the middleware 143, the API 145, or the application 147 to access individual elements of the electronic device 100 in order to control or manage the system resources.

The middleware 143 may serve as an intermediary so that the API 145 or the application 147 communicates and exchanges data with the kernel 141.

Furthermore, the middleware 143 may handle one or more task requests received from the application 147 according to a priority order. For example, the middleware 143 may assign at least one application 147 a priority for using the system resources (e.g., the bus 110, the processor 120, the memory 130, and the like) of the electronic device 100. For example, the middleware 143 may handle the one or more task requests according to the priority assigned to the at least one application, thereby performing scheduling or load balancing with respect to the one or more task requests.

The API 145, which is an interface for allowing the application 147 to control a function provided by the kernel 141 or the middleware 143, may include, for example, at least one interface or function (e.g., instructions) for file control, window control, image processing, character control, and the like.

The input/output interface 150 may serve to transfer an instruction or data input from a user or another external device to other elements of the electronic device 100. Furthermore, the input/output interface 150 may output instructions or data received from other elements of the electronic device 100 to the user or another external device.

The display 160 may include, for example, a liquid crystal display (LCD), a light-emitting diode (LED) display, an organic light-emitting diode (OLED) display, a microelectromechanical systems (MEMS) display, or an electronic paper display. The display 160 may present various content (e.g., a text, an image, a video, an icon, a symbol, and the like) to the user. The display 160 may include a touch screen, and may receive a touch, gesture, proximity or hovering input from an electronic pen or a part of a body of the user.

The communication interface 170 may set communications between the electronic device 100 and a first external electronic device 102, a second external electronic device 104, or a server 106. For example, the communication interface 170 may be connected to a network 162 via wireless communications or wired communications so as to communicate with the second external electronic device 104 or the server 106.

The wireless communications may employ at least one of cellular communication protocols such as long-term evolution (LTE), LTE-advance (LTE-A), code division multiple access (CDMA), wideband CDMA (WCDMA), universal mobile telecommunications system (UMTS), wireless broadband (WiBro), or global system for mobile communications (GSM). The wireless communications may include, for example, a short-range communications 164. The short-range communications may include at least one of wireless fidelity (Wi-Fi), Bluetooth, near field communication (NFC), or GNSS. The GNSS may include, for example, at least one of global positioning system (GPS), global navigation satellite system (GLONASS), BeiDou navigation satellite system (BeiDou), or Galileo, the European global satellite-based navigation system according to a use area or a bandwidth. Hereinafter, the term “GPS” and the term “GNSS” may be interchangeably used. The wired communications may include at least one of a universal serial bus (USB), high definition multimedia interface (HDMI), recommended standard 232 (RS-232), plain old telephone service (POTS), and the like. The network 162 may include at least one of telecommunications networks, for example, a computer network (e.g., local area network (LAN) or wide area network (WAN)), the Internet, or a telephone network.

The types of the first external electronic device 102 and the second external electronic device 104 may be the same as or different from the type of the electronic device 100. According to an embodiment of the present disclosure, the server 106 may include a group of one or more servers. A portion or all of operations performed in the electronic device 100 may be performed in the first electronic device 102, the second external electronic device 104, or the server 106. When the electronic device 100 performs a certain function or service automatically or in response to a request, the electronic device 100 may request at least a portion of functions related to the function or service from the first electronic device 102, the second external electronic device 104, or the server 106, instead of or in addition to performing the function or service for itself. The first electronic device 102, the second external electronic device 104, or the server 106 may perform the requested function or additional function, and may transfer a result of the performance to the electronic device 100. The electronic device 100 may use a received result itself or additionally process the received result to provide the requested function or service. To this end, for example, a cloud computing technology, a distributed computing technology, or a client-server computing technology may be used.

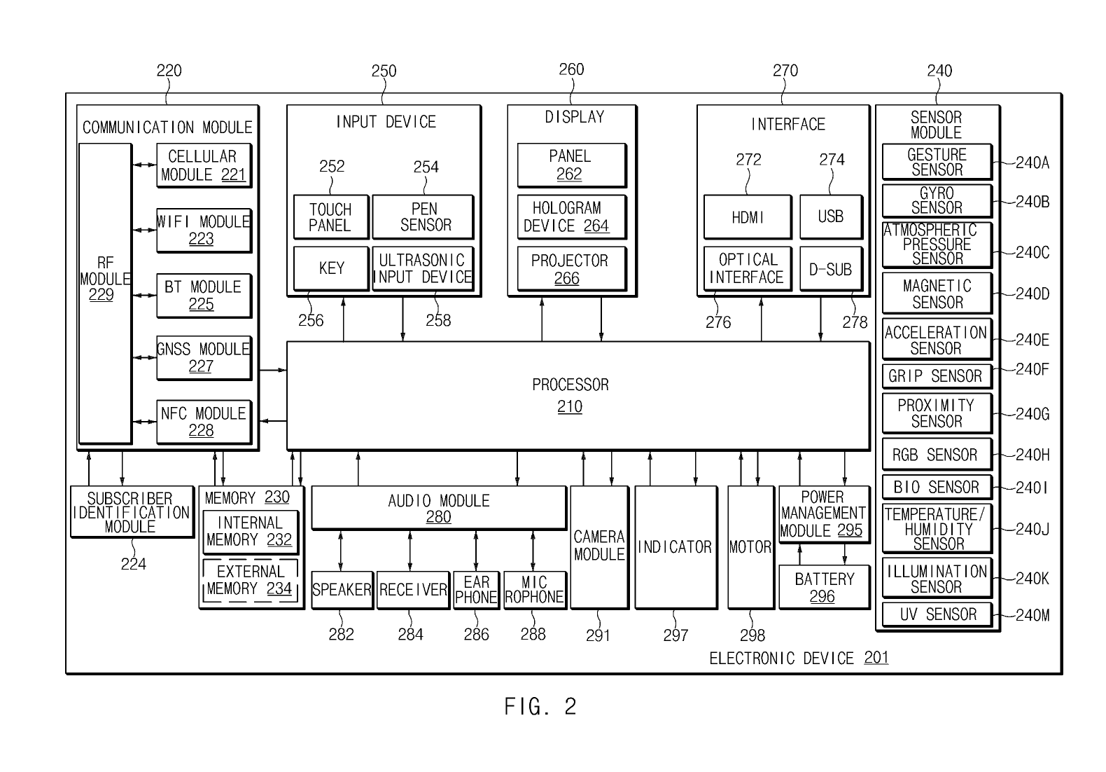

FIG. 2 is a block diagram illustrating an electronic device according to an embodiment of the present disclosure. Referring to FIG. 2, an electronic device 200 may include, for example, a part or the entirety of the electronic device 100 illustrated in FIG. 1. The electronic device 200 includes at least one processor (e.g., AP) 210, a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298.

The processor 210 may run an operating system or an application program so as to control a plurality of hardware or software elements connected to the processor 210, and may process various data and perform operations. The processor 210 may be implemented with, for example, a system on chip (SoC). According to an embodiment of the present disclosure, the processor 210 may further include a graphic processing unit (GPU) and/or an image signal processor. The processor 210 may include at least a portion (e.g., a cellular module 221) of the elements illustrated in FIG. 2. The processor 210 may load, on a volatile memory, an instruction or data received from at least one of other elements (e.g., a nonvolatile memory) to process the instruction or data, and may store various data in a nonvolatile memory.

The communication module 220 may have a configuration that is the same as or similar to that of the communication interface 170 of FIG. 1. The communication module 220 includes, for example, a cellular module 221, a Wi-Fi module 223, a Bluetooth module 225, a GNSS module 227 (e.g., a GPS module, a GLONASS module, a BeiDou module, or a Galileo module), an NFC module 228, and a radio frequency (RF) module 229.

The cellular module 221 may provide, for example, a voice call service, a video call service, a text message service, or an Internet access service through a communication network. The cellular module 221 may identify and authenticate the electronic device 200 in the communication network using the SIM 224 (e.g., a SIM card). The cellular module 221 may perform at least a part of functions that may be provided by the processor 210. The cellular module 221 may include a communication processor (CP).

Each of the Wi-Fi module 223, the Bluetooth module 225, the GNSS module 227 and the NFC module 228 may include, for example, a processor for processing data transmitted/received through the modules. According to an embodiment of the present disclosure, at least a part (e.g., two or more) of the cellular module 221, the Wi-Fi module 223, the Bluetooth module 225, the GNSS module 227, and the NFC module 228 may be included in a single integrated chip (IC) or IC package.

The RF module 229 may transmit/receive, for example, communication signals (e.g., RF signals). The RF module 229 may include, for example, a transceiver, a power amp module (PAM), a frequency filter, a low noise amplifier (LNA), an antenna, and the like. According to an embodiment of the present disclosure, at least one of the cellular module 221, the Wi-Fi module 223, the Bluetooth module 225, the GNSS module 227, or the NFC module 228 may transmit/receive RF signals through a separate RF module.

The SIM 224 may include, for example, an embedded SIM and/or a card containing the subscriber identity module, and may include unique identification information (e.g., an integrated circuit card identifier (ICCID)) or subscriber information (e.g., international mobile subscriber identity (MI)).

The memory 230 (e.g., the memory 130) includes, for example, an internal memory 232 or an external memory 234. The internal memory 232 may include at least one of a volatile memory (e.g., a dynamic RAM (DRAM), a static RAM (SRAM), a synchronous dynamic RAM (SDRAM), and the like), a nonvolatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, a NOR flash memory, and the like)), a hard drive, or a solid state drive (SSD).

The external memory 234 may include a flash drive such as a compact flash (CF), a secure digital (SD), a micro-sd, a mini-sd, an extreme digital (xD), a multimedia card (MMC), a memory stick, and the like. The external memory 234 may be operatively and/or physically connected to the electronic device 200 through various interfaces.

The sensor module 240 may, for example, measure physical quantity or detect an operation state of the electronic device 200 so as to convert measured or detected information into an electrical signal. The sensor module 240 includes, for example, at least one of a gesture sensor 240A, a gyro sensor 240B, a barometric pressure sensor 240C, a magnetic sensor 240D, an acceleration sensor 240E, a grip sensor 240F, a proximity sensor 240G, a color sensor 240H (e.g., a red/green/blue (RGB) sensor), a biometric sensor 240I, a temperature/humidity sensor 240J, an illumination sensor 240K, or an ultraviolet (UV) sensor 240M. Additionally or alternatively, the sensor module 240 may include, for example, an olfactory sensor (E-nose sensor), an electromyography (EMG) sensor, an electroencephalogram (EEG) sensor, an electrocardiogram (ECG) sensor, an infrared (IR) sensor, an iris recognition sensor, and/or a fingerprint sensor. The sensor module 240 may further include a control circuit for controlling at least one sensor included therein. The electronic device 200 may further include a processor configured to control the sensor module 240 as a part of the processor 210 or separately, so that the sensor module 240 is controlled while the processor 210 is in a sleep state.

The input device 250 includes, for example, a touch panel 252, a (digital) pen sensor 254, a key 256, or an ultrasonic input device 258. The touch panel 252 may employ at least one of capacitive, resistive, infrared, and ultraviolet sensing methods. The touch panel 252 may further include a control circuit. The touch panel 252 may further include a tactile layer so as to provide a haptic feedback to a user.

The (digital) pen sensor 254 may include, for example, a sheet for recognition which is a part of a touch panel or is separate. The key 256 may include, for example, a physical button, an optical button, or a keypad. The ultrasonic input device 258 may sense ultrasonic waves generated by an input tool through a microphone 288 so as to identify data corresponding to the ultrasonic waves sensed.

The display 260 (e.g., the display 160) includes a panel 262, a hologram device 264, or a projector 266. The panel 262 may have a configuration that is the same as or similar to that of the display 160 of FIG. 1. The panel 262 may be, for example, flexible, transparent, or wearable. The panel 262 and the touch panel 252 may be integrated into a single module. The hologram device 264 may display a stereoscopic image in a space using a light interference phenomenon. The projector 266 may project light onto a screen so as to display an image. The screen may be disposed in the inside or the outside of the electronic device 200. According to an embodiment of the present disclosure, the display 260 may further include a control circuit for controlling the panel 262, the hologram device 264, or the projector 266.

The interface 270 includes, for example, an HDMI 272, a USB 274, an optical interface 276, or a D-subminiature (D-sub) 278. The interface 270, for example, may be included in the communication interface 170 illustrated in FIG. 1. Additionally or alternatively, the interface 270 may include, for example, a mobile high-definition link (MHL) interface, an SD card/multi-media card (MMC) interface, or an infrared data association (IrDA) interface.

The audio module 280 may convert, for example, a sound into an electrical signal or vice versa. At least a portion of elements of the audio module 280 may be included in the input/output interface 150 illustrated in FIG. 1. The audio module 280 may process sound information input or output through a speaker 282, a receiver 284, an earphone 286, or the microphone 288.

The camera module 291 is, for example, a device for shooting a still image or a video. According to an embodiment of the present disclosure, the camera module 1091 may include at least one image sensor (e.g., a front sensor or a rear sensor), a lens, an image signal processor (ISP), or a flash (e.g., an LED or a xenon lamp).

The power management module 295 may manage power of the electronic device 200. According to an embodiment of the present disclosure, the power management module 295 may include a power management integrated circuit (PMIC), a charger integrated circuit (IC), or a battery gauge. The PMIC may employ a wired and/or wireless charging method. The wireless charging method may include, for example, a magnetic resonance method, a magnetic induction method, an electromagnetic method, and the like. An additional circuit for wireless charging, such as a coil loop, a resonant circuit, a rectifier, and the like, may be further included. The battery gauge may measure, for example, a remaining capacity of the battery 296 and a voltage, current or temperature thereof while the battery is charged. The battery 296 may include, for example, a rechargeable battery and/or a solar battery.

The indicator 297 may display a specific state of the electronic device 200 or a part thereof (e.g., the processor 210), such as a booting state, a message state, a charging state, the like. The motor 298 may convert an electrical signal into a mechanical vibration, and may generate a vibration or haptic effect. A processing device (e.g., a GPU) for supporting a mobile TV may be included in the electronic device 200. The processing device for supporting a mobile TV may process media data according to the standards of digital multimedia broadcasting (DMB), digital video broadcasting (DVB), MediaFLO™, and the like.

Each of the elements described herein may be configured with one or more components, and the names of the elements may be changed according to the type of an electronic device. According to an embodiment of the present disclosure, an electronic device may include at least one of the elements described herein, and some elements may be omitted or other additional elements may be added. Furthermore, some of the elements of the electronic device may be combined with each other so as to form one entity, so that the functions of the elements may be performed in the same manner as before the combination.

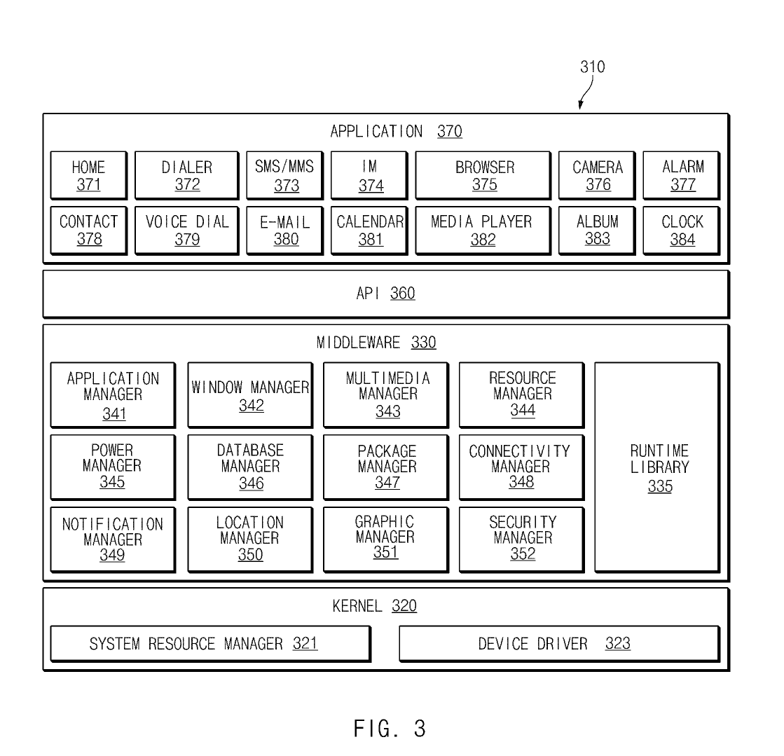

FIG. 3 is a block diagram illustrating a program module according to an embodiment of the present disclosure. Referring to FIG. 3, a program module 310 (e.g., the program 140) may include an operating system (OS) for controlling a resource related to an electronic device (e.g., the electronic device 100) and/or various applications (e.g., the application program 147) running on the OS. The operating system may be, for example, Android, iOS, Windows, Symbian, Tizen, and the like.

The program module 310 includes a kernel 320, a middleware 330, an API 360, and/or an application 370. At least a part of the program module 310 may be preloaded on an electronic device or may be downloaded from the first electronic device 102, the second external electronic device 104, or the server 106.

The kernel 320 (e.g., the kernel 141) includes, for example, a system resource manager 321 or a device driver 323. The system resource manager 321 may perform control, allocation, or retrieval of a system resource. According to an embodiment of the present disclosure, the system resource manager 321 may include a process management unit, a memory management unit, a file system management unit, and the like. The device driver 323 may include, for example, a display driver, a camera driver, a Bluetooth driver, a shared memory driver, a USB driver, a keypad driver, a Wi-Fi driver, an audio driver, or an inter-process communication (IPC) driver.

The middleware 330, for example, may provide a function that the applications 370 require in common, or may provide various functions to the applications 370 through the API 360 so that the applications 370 may efficiently use limited system resources in the electronic device. According to an embodiment of the present disclosure, the middleware 330 (e.g., the middleware 143) includes at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module that a complier uses to add a new function through a programming language while the application 370 is running. The runtime library 335 may perform a function for input/output management, memory management, or an arithmetic function.

The application manager 341 may mange, for example, a life cycle of at least one of the applications 370. The window manager 342 may manage a GUI resource used in a screen. The multimedia manager 343 may recognize a format required for playing various media files and may encode or decode a media file using a codec matched to the format. The resource manager 344 may manage a resource such as a source code, a memory, or a storage space of at least one of the applications 370.

The power manager 345, for example, may operate together with a basic input/output system (BIOS) to manage a battery or power and may provide power information required for operating the electronic device. The database manager 346 may generate, search, or modify a database to be used in at least one of the applications 370. The package manager 347 may manage installation or update of an application distributed in a package file format.

The connectivity manger 348 may manage wireless connection of Wi-Fi, Bluetooth, and the like. The notification manager 349 may display or notify an event such as message arrival, appointments, and proximity alerts in such a manner as not to disturb a user. The location manager 350 may manage location information of the electronic device. The graphic manager 351 may manage a graphic effect to be provided to a user or a user interface related thereto. The security manager 352 may provide various security functions required for system security or user authentication. According to an embodiment of the present disclosure, in the case in which an electronic device 100 includes a phone function, the middleware 330 may further include a telephony manager for managing a voice or video call function of the electronic device.

The middleware 330 may include a middleware module for forming a combination of various functions of the above-mentioned elements. The middleware 330 may provide a module specialized for each type of an operating system to provide differentiated functions. Furthermore, the middleware 330 may delete a part of existing elements or may add new elements dynamically.

The API 360 (e.g., the API 145) which is, for example, a set of API programming functions may be provided in different configurations according to an operating system. For example, in the case of Android or iOS, one API set may be provided for each platform, and, in the case of Tizen, at least two API sets may be provided for each platform.

The application 370 (e.g., the application 147), for example, includes at least one application capable of performing functions such as a home 371, a dialer 372, an SMS/MMS 373, an instant message (IM) 374, a browser 375, a camera 376, an alarm 377, a contact 378, a voice dial 379, an e-mail 380, a calendar 381, a media player 382, an album 383, a clock 384, health care (e.g., measure an exercise amount or blood sugar level), or environmental information provision (e.g., provide air pressure, humidity, or temperature information).

According to an embodiment of the present disclosure, the application 370 may include an information exchange application for supporting information exchange between the electronic device 100 and the first electronic device 102 or the second external electronic device 104. The information exchange application may include, for example, a notification relay application for relaying specific information to the external electronic device or a device management application for managing the external electronic device.

For example, the notification relay application may have a function for relaying, to the first electronic device 102 or the second external electronic device 104, notification information generated in another application (e.g., an SMS/MMS application, an e-mail application, a health care application, an environmental information application, and the like) of the electronic device. Furthermore, the notification relay application may receive notification information from the external electronic device and may provide the received notification information to the user.

The device management application, for example, may manage (e.g., install, delete, or update) at least one function (e.g., turn-on/turn off of the external electronic device itself (or some elements) or the brightness (or resolution) adjustment of a display) of the first electronic device 102 or the second external electronic device 104, communicating with the electronic device, an application running in the external electronic device, or a service (e.g., a call service, a message service, and the like) provided from the external electronic device.

According to an embodiment of the present disclosure, the application 370 may include a specified application (e.g., a healthcare application of a mobile medical device) according to an attribute of the first electronic device 102 or the second external electronic device 104. The application 370 may include an application received from the first electronic device 102 or the second external electronic device 104). The application 370 may include a preloaded application or a third-party application downloadable from a server. The names of the elements of the program module 310 illustrated may vary with the type of an operating system.

According to various embodiments of the present disclosure, at least a part of the program module 310 may be implemented with software, firmware, hardware, or a combination thereof. At least a part of the program module 310, for example, may be implemented (e.g., executed) by a processor (e.g., the processor 210). At least a part of the program module 310 may include, for example, a module, a program, a routine, sets of instructions, or a process for performing at least one function.

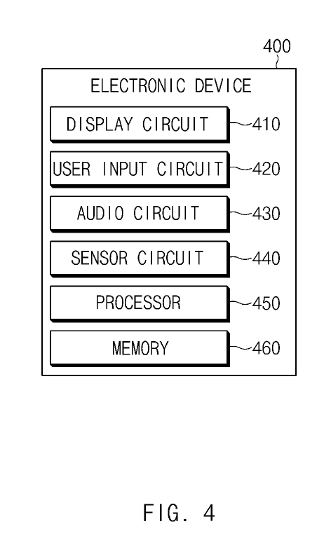

FIG. 4 is a block diagram of an electronic device for providing a user interface (UI) according to an embodiment of the present disclosure. Referring to FIG. 4, the electronic device 400 includes a display circuit 410, a user input circuit 420, a sensor circuit 430, an audio circuit 440, a processor 450, and a memory 460.

The display circuit 410 (for example, the display circuit 160 and the display circuit 260) may display various content on the screen of the electronic device 400.

The user input circuit 420 (for example, the input device 250) may process a user input from a user. The user input may be a touch input using a user's finger or a stylus (for example, an electronic pen). Additionally, the user input may include an input for applying an input through an electrical change without directly contacting the screen by a user's finger or a stylus, for example, a hover input. According to an embodiment of the present disclosure, the user input circuit 420 may be a touch IC.

The user input circuit 420 may distinguish and process various types of the touch input. The type of the user input, for example, may include a touch input, a touch move, a touch release, touch and drag, and drag and drop. Additionally, the user input may include a user's gesture, gaze, and voice.

According to an embodiment of the present disclosure, the user input circuit 420 may receive a user input by using various sensors included in the sensor circuit 430 (for example, the sensor circuit 240). For example, the user input circuit 420 may receive a user's touch input, electronic pen input, or hover input by using a touch sensor. Additionally, the user input circuit 420 may receive a user's gaze as a user input by using an infrared sensor or an image sensor. Furthermore, the user input circuit 420 may receive a user's gesture as a user input by using an infrared sensor or a motion recognition sensor.

According to an embodiment of the present disclosure, the user input circuit 420 may be an electronic pen input through a wireless receiver. Additionally, the user input circuit 420 may receive a user's voice as a user input by using a microphone.

The audio circuit 440 (for example, the audio circuit 380) may reproduce a sound source. The played sound source may be provided to a user through a speaker or an earphone connected to the electronic device 400 in a wired or wireless manner.

The processor 450 may display at least one object on the screen through the display circuit 410. The object may mean each icon included in a keypad displayed on a call application, a text application, or a calculation application. Additionally, the object may be an album cover image displayed on a music application. Furthermore, the object may represent each of a plurality of pixels or a plurality of areas of a canvas displayed on a memo application or a drawing application.

The processor 450 may match a sound source to the object. The sound source may be matched differently according to the type of the object. For example, a sound source on an icon included in the keypad may be a conventionally used mechanical sound or scale (do re mi fa so la ti do). A sound source on the album cover image may be at least part of a track listed on the album. In this case, the at least part may be an area of an intro, a prelude, a bridge, a postlude, or a climax in the listed track. When the album cover image is displayed for a specific track among a plurality of tracks listed on the album (for example, the specific track is being played or when the album cover image is selected, the specific track is played), the sound source may correspond to the specific track.

According to an embodiment of the present disclosure, when the object corresponds to a plurality of pixels or areas of a canvas displayed on the memo application or the drawing application, a sound source corresponding to the object may be a writing tool. For example, when a pen is selected as a writing tool from the memo application or the drawing application, the sound source may be a sound generated when drawing or writing with the pen. Additionally, when a brush is selected from the application, the sound source may be a sound generated when painting with the brush. Similarly, when an eraser is selected from the application, the sound source may be a sound generated when erasing a text or a picture with the brush. Each sound may be pre-stored in the memory 460.

The processor 450 may generate virtual space coordinates for the object. Additionally, the processor 450 may set a sound effect on the sound source based on the generated virtual space coordinates.

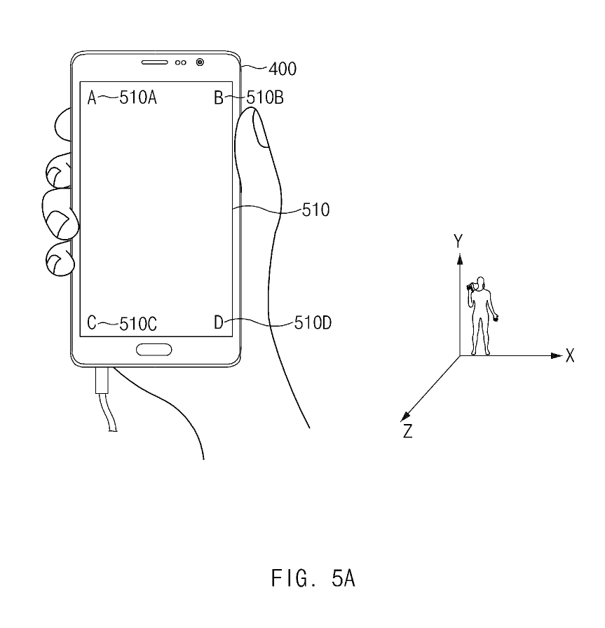

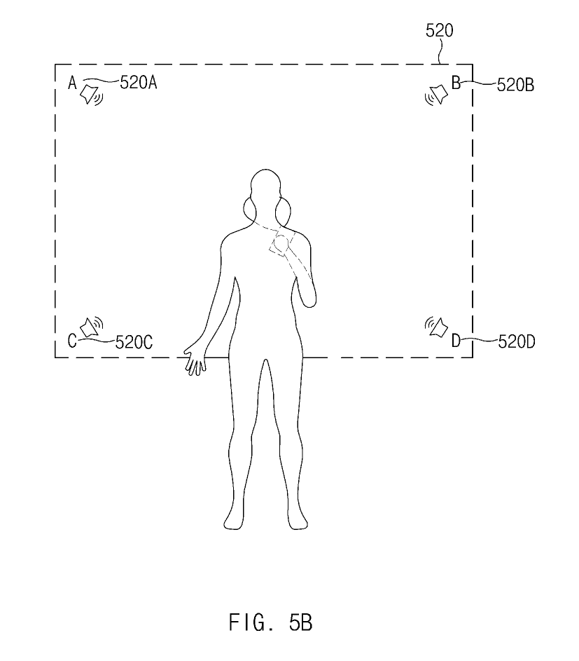

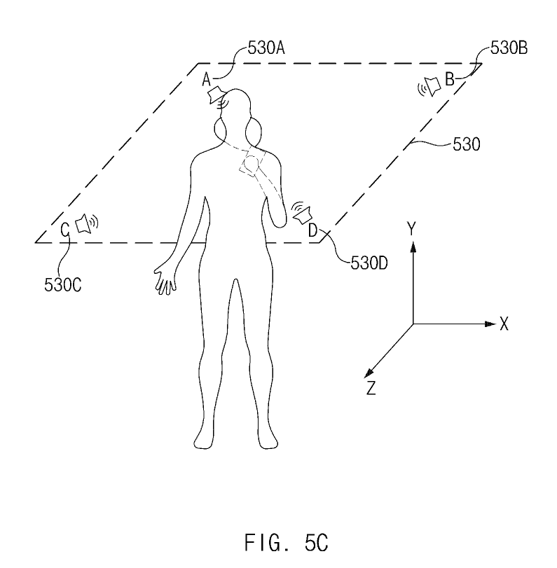

The virtual space coordinates may be coordinates corresponding to a space for surrounding the electronic device 400. Accordingly, the sound effect may be configured to allow a user to recognize as if the sound source was played at the converted virtual space coordinates. Detailed contents are described with reference to FIG. 5.

According to an embodiment of the present disclosure, the sound effect, for example, may be provided through a head related transfer function (HRTF) algorithm. As another example, the sound effect may be provided through an algorithm that simply changes the playback size (for example, volume), phase (for example, the occurrence time points of the left (L) channel and the right (R) channel of a sound source), and reverberation of the sound source. For example, the electronic device 400 may output the size of a sound from far and the size of a sound from near differently. As another example, the electronic device 400 may provide a sound effect for changing at least one of the phase and/or reverberation of a sound from different directions.

According to an embodiment of the present disclosure, the electronic device 400 may change the playback size, phase, and reverberation of a sound source with respect to each of the L channel and/or the R channel through an algorithm, and output each of the L channel and the R channel as audio to provide a sound effect through a user's earphone. However, the sound effect may be provided when a sound source is outputted through an earphone, and also may be provided similarly when a sound source is outputted through a speaker.

The processor 450 may receive a user's gaze input through the user input circuit 420, and generate virtual space coordinates based on a direction of the user's gaze.

The processor 450 may receive a user input for selecting the object through the user input circuit 420. In this case, the processor 450 may apply the sound effect to a sound source corresponding to the object and reproduce it.

The processor 450 may receive a user input for moving the object through the user input circuit 420. For example, the user input may be drag and drop or a touch move on the object. The processor 450 may change virtual coordinates corresponding to the object along a traveling path of the object. Additionally, the processor 450 may update the sound effect based on the changed virtual coordinates. The operation may be processed substantially in real time. For example, the processor 450 may provide a seamless sound source and a seamless sound effect to a user by continuously updating the sound effect each time the object moves.

The processor 450 may display a plurality of objects on a screen through the display circuit 410. In this case, the processor 450 may generate virtual space coordinates for each of the plurality of objects, match a sound source to each, and perform a playback by applying a sound effect. The processor 450 may mix a sound source corresponding to each of the plurality of objects and reproduce them simultaneously. When a sound source is a stereo sound source, the processor 450 separates the L channel from the R channel, and after applying an algorithm for a sound effect with respect to each channel, mix a plurality of L channels and a plurality of R channels. According to an embodiment of the present disclosure, the processor 450 may reproduce only a sound source for at least part of the plurality of objects. For example, the processor 450 may determine the number of sound sources to be played through a listening area concept. For example, when the listening area is configured to be broad, this means that an audible space is included widely at virtual space coordinates, and at this point, sound sources included in this space range are actually played so that a user may listen to more sound sources at the same time. On the other hand, when the listening area is configured to be narrow, this means that an audible space is included narrowly at virtual space coordinates, and at this point, sound sources included in this space range are actually played so that a user may listen to less sound sources at the same time. Accordingly, the processor 450 may determine whether to reproduce each of a plurality of sound sources according to whether or not a listening area is included.

When the plurality of objects are moved together based on a user input for moving the object, the processor 450 may change virtual coordinates to match a traveling path of each of the plurality of objects, and update and reproduce the sound effect.

According to an embodiment of the present disclosure, the providing of the sound source may be stopped when an operation for finishing the user input is finished (for example, an operation for touch-releasing a touch input is released) is received.

The processor 450 may receive a drag input for sequentially selecting a plurality of objects through the user input circuit 420. For example, when a user draws a picture on a memo application or a drawing application, an input for sequentially dragging continuous pixels or areas may be received. In this case, the processor 450 may sequentially reproduce a plurality of sound sources that respectively correspond to the plurality of objects.

The processor 450 may detect a user's movement during the playback of the sound source. When the user's movement is detected, the processor 450 may update the sound effect so as to maintain the converted virtual space coordinates based on the user.

The memory 460 (for example, the memory 130 and the memory 230) may store instructions for operations performed by the processor 450. Data stored in the memory 460 includes data input and output between each of components in the electronic device 400 and data input and output between the electronic device 400 and components outside the electronic device 400. For example, the memory 460 may store the above-mentioned music listening application, call application, text application, calculation application, memory application, or drawing application. Additionally, the memory 460 may store an algorithm (for example, an HRTF algorithm) used for the sound effect. As mentioned above, the algorithm may be an HRTF algorithm, or may be an algorithm for changing at least one of the playback size, phase, and reverberation of a sound source.

It is apparent to those skilled in the art that each of the display circuit 410, the user input circuit 420, the sensor circuit 430, the audio circuit 440, the processor 450, and the memory 460 may be implemented separately from the electronic device 400 or at least one of them may be integrated.

The configuration of the electronic device 400 shown in FIG. 4 is merely one implementation example of the present disclosure and various modifications are possible. For example, the electronic device 400 may further include a user interface for receiving a certain instruction or information from a user. In this case, the user interface may be an input device such as a keyboard, a mouse, and so on in general and may be a graphical user interface (GUI) displayed on the screen of the electronic device 400.

Additionally, the electronic device 400 may further include a communication circuit (for example, the communication circuit 170 and the communication circuit 220) that communicates with an external electronic device. In the case that a wireless speaker (for example, a Bluetooth speaker) or a wireless earphone (for example, a Bluetooth earphone) is used, the electronic device 400 may use the communication circuit to deliver sound source playback signals to the wireless speaker or the wireless earphone.

According to an embodiment of the present disclosure, in order to use a group reproduce service with an external electronic device, the electronic device 400 may be linked to the external device through the communication circuit. If the speaker of each of the electronic device 400 and the external electronic device does not support a stereo mode and supports only a mono mode, the group play service is a service for supporting more than two channels by using each of the electronic device 400 and the external electronic device as one speaker.

If there is no speaker in the electronic device 400, the electronic device 400 may be linked to two external electronic devices through the communication circuit, and integrate the two external electronic devices to use more than two channels.

FIG. 5A illustrates the electronic device 400 and coordinates where the electronic device 400 is disposed according to an embodiment of the present disclosure. Referring to the drawing shown on the left of FIG. 5A, the electronic device 400 may display a first object 510A, a second object 510B, a third object 510C, and a fourth object 510D on a screen 510.

A sound source is matched to each of the first object 510A, the second object 510B, the third object 510C, and the fourth object 510D. The sound source may vary by each object, but the same sound source may be matched to each object.

The drawing shown on the right of FIG. 5A illustrates a user holding the electronic device 400 and its coordinate system. Referring to the right drawing of FIG. 5A, a user folds their arm while holding the electronic device 400 with the right hand and stares at the front of the electronic device 400.

Hereinafter, it is described in FIG. 5A and other drawings that a horizontal axis based on a user is an X-axis, a vertical axis (that is, a direction that the user stands up) is a Y-axis, and a user's front direction is a Z-axis.

FIG. 5B and FIG. 5C illustrate virtual space coordinates configured for an object displayed on the electronic device 400 of FIG. 5A.

Referring to FIG. 5B, a virtual space 520 may be a front space (that is, an X-Y plane) in the Z-axis direction from a user.

According to an embodiment of the present disclosure, a position where a sound source corresponding to the first object 510A is to be played may be a first position 520A. Additionally, a position where a sound source corresponding to the second object 510B is to be played may be a second position 520B. Additionally, a position where a sound source corresponding to the third object 510C is to be played may be a third position 520C at a user's front left lower end. Additionally, a position where a sound source corresponding to the fourth object 510D is to be played may be a fourth position 520D at a user's front right lower end.

Referring to FIG. 5C, a virtual space 530 may be a horizontal space (that is, an X-Z plane) at a predetermined height from a user.

According to an embodiment of the present disclosure, a position where a sound source corresponding to the first object 510A is to be played may be a first position 530A that is at a user's left remote distance. Additionally, a position where a sound source corresponding to the second object 510B is to be played may be a second position 530B that is at a user's right remote distance. Additionally, a position where a sound source corresponding to the third object 510C is to be played may be a third position 530C that is at a user's left short distance. Additionally, a position where a sound source corresponding to the fourth object 510D is to be played may be a fourth position 530D that is at a user's right short distance.

According to an embodiment of the present disclosure, the virtual space 520 shown in FIG. 5B may not be located at the user's front and may be a plane space including a user. The virtual space 530 shown in FIG. 5C also may be a plane space including a user, and the third position 530c and the fourth position 530D may be located at the user's rear.

Additionally, the virtual spaces 520 and 530 in FIGS. 5B and 5C are illustrated as a plane but according to an embodiment of the present disclosure, the virtual spaces 520 and 530 may be a three-dimensional space. For example, when objects displayed on the screen of the electronic device 400 are expressed three-dimensionally, the virtual spaces 520 and 530 may be a three-dimensional space. On the other hand, when objects displayed on the screen of the electronic device 400 are expressed two-dimensionally, the virtual spaces 520 and 530 may be a two dimensional plane space as shown in FIGS. 5B or 5C.

It is shown in FIGS. 5A to 5C as if a user received a sound source through an earphone connected to the electronic device 400. According to an embodiment of the present disclosure, the electronic device 400 may provide the sound source through a speaker in addition to an earphone (or headphone). When the earphone or the speaker is used, the electronic device 400 may provide a sound effect to a sound source to allow a user to feel a spatial sense from the sound.

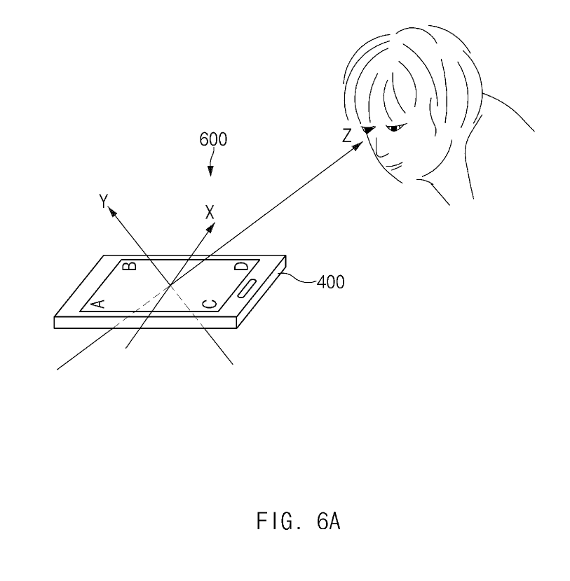

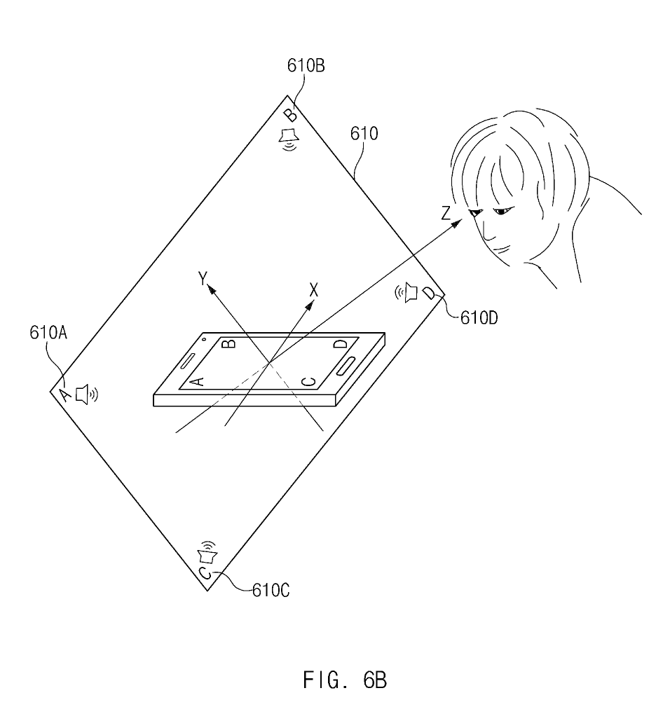

FIG. 6A illustrates a user's gaze looking down at an electronic device according to an embodiment of the present disclosure. Objects A, B, C, and D may be displayed on the screen of the electronic device 400.

Referring to a coordinate system 600 shown in FIG. 6A, a direction that a user views the electronic device 400 may be referred to as a Z-axis. Additionally, the coordinate system 600 may include an X-axis and a Y-axis that are orthogonal to the Z-axis and respectively correspond to a user's horizontal axis and vertical axis based on the user.

When the electronic device 400 is fixed, and a user's position is changed, each of the X-axis, Y-axis, and Z-axis of the coordinate system 600 may be changed.

FIG. 6B illustrates a virtual space 610 created based on a user's gaze of FIG. 6A according to an embodiment of the present disclosure.

Referring to FIG. 6B, a virtual space 610 may be a plane space vertical to a user's gaze. Additionally, unlike a virtual space in FIG. 5B or FIG. 5C, the virtual space 610 may vary based on a user's gaze.

Virtual space coordinates on each of the objects A, B, C, and D displayed on the screen of the electronic device 400 may be configured with a first position 610A, a second position 610B, a third position 610C, and a fourth position 610D.

Although the virtual space 610 shown in FIG. 6B is expressed as a two dimensional plane space, according to an embodiment of the present disclosure, it may be a three-dimensional space.

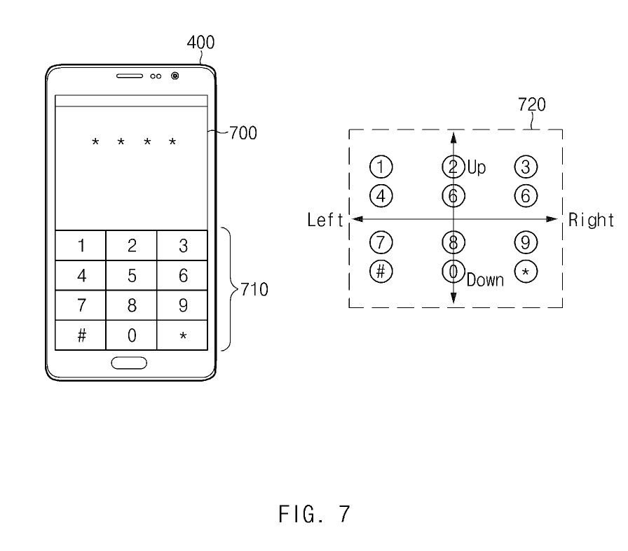

FIG. 7 illustrates a virtual space coordinate configuration applied to a keypad object according to an embodiment of the present disclosure.

Referring to the drawing shown on the left of FIG. 7, the electronic device 400 may display an application 700 on the screen. The application 700 may use the keypad 710, for example, and include a call application, a text application, or a calculation application.

The drawing shown on the right of FIG. 7 may represent a virtual space 720 corresponding to the keypad 710. Similar to the embodiment of FIG. 5B, the virtual space 720 may be a space that stands vertical to the user's front, and similar to the embodiment of FIG. 5C, may be a space that expands horizontally toward the front at a user's predetermined height. Hereinafter, it is assumed and described that the virtual space 720 is a space according to the embodiment of FIG. 5B.

The electronic device 400 may generate virtual space coordinates on objects included in the keypad 710. For example, virtual space coordinates for the key “1” as an object included in the keypad 710 may be a user's left upper end. Additionally, virtual space coordinates for the key “*” may be a user's right lower end.

When receiving a user input for the key “1” as an object included in the keypad 710, the electronic device 400 may reproduce the sound source by applying a sound effect which makes a user (a listener) feel like a sound source matched to the key “1” is played at the virtual space coordinates.

Similarly, when receiving a user input for the key “*” as an object included in the keypad 710, the electronic device 400 may apply and play a sound effect on a sound source that matches the key “*” is played as if it was played at the configured virtual space coordinates.

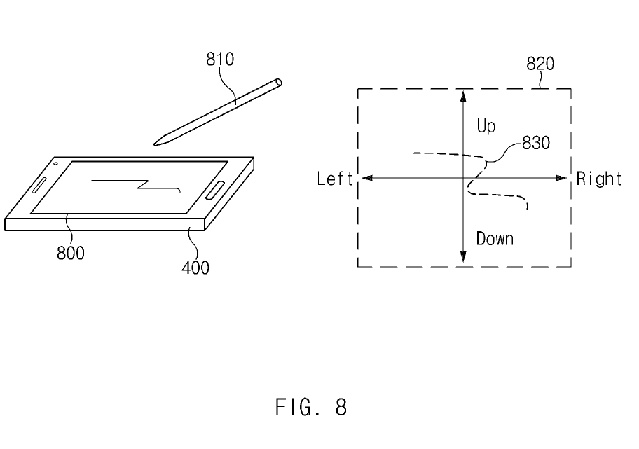

FIG. 8 illustrates a virtual space coordinate configuration applied to a canvas object according to an embodiment of the present disclosure.

Referring to the drawing shown on the left of FIG. 8, the electronic device 400 may display an application 800 on the screen. The application 800, for example, may include a memo application or a drawing application. Although it is shown in FIG. 8 that the electronic device 400 receives a user input by using an electronic pen, according to an embodiment of the present disclosure, the electronic device 400 may receive a user input through a user's finger, for example, a touch input. An object included in the application 800 may be one area or one pixel of a canvas, and the application 800 may include a plurality of objects.

The drawing shown on the right of FIG. 8 may represent a virtual space 820 corresponding to the canvas. Similar to the embodiment of FIG. 5B, the virtual space 820 may be a space that stands vertical to the user's front, and similar to the embodiment of FIG. 5C, may be a space that expands horizontally toward the front at a user's predetermined height. Hereinafter, it is assumed and described that the virtual space 820 is a space according to the embodiment of FIG. 5B.

According to an embodiment of the present disclosure, the electronic device 400 may receive a user input 810 for drawing a line as shown on the left of FIG. 8. For example, the user input 810 may be a drag input. The user input 810 may include a touch and release for each of a plurality of continuous objects. The electronic device 400 may calculate virtual space coordinates of each of a plurality of objects that are sequentially touched through the user input 810, and apply a sound effect to allow a user to feel as if a sound source corresponding to each of a plurality of objects was sequentially played. If a sound source corresponding to each of a plurality of objects is the same, in the case that the electronic device 400 sequentially plays a sound source corresponding to each of a plurality of objects, a user may feel as if the sound source moved along a trajectory 830 shown in the virtual space 820.

According to an embodiment of the present disclosure, the sound source may be a sound generated when a writing tool corresponding to the user input is used on the memo application or the drawing application. Accordingly, in the case of FIG. 8, when a writing tool corresponding to the user input 810 is a brush, a user may feel a sound that brushing starts from a left upper end and moves to the right and then, the brush moves toward the left lower end direction and then moves to the right. At this point, a user may hear a sound that a brushing direction is changed at a point where a direction of the trajectory 830 is changed.

Additionally, according to an embodiment of the present disclosure, the electronic device 400 may apply a sound effect so as to change the playback size of the sound source based on the speed and intensity that a user inputs the user input 810.

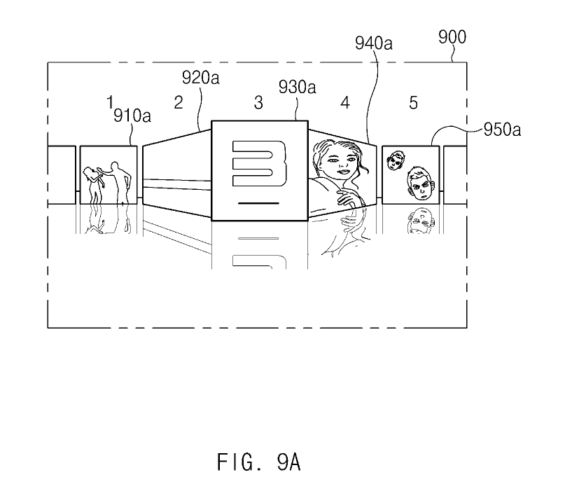

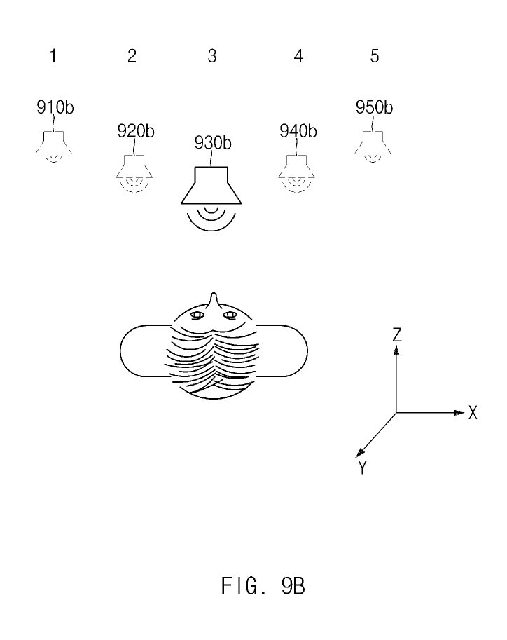

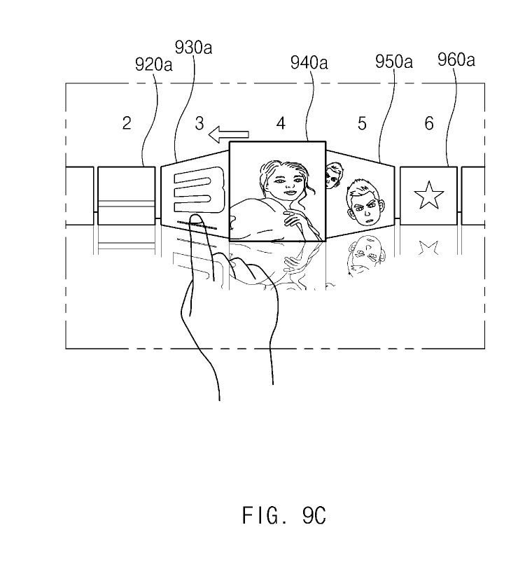

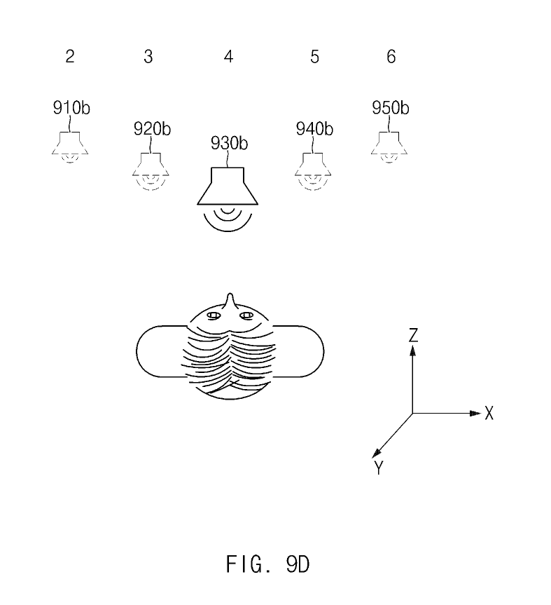

An application for displaying an object two-dimensionally is described as one embodiment of FIGS. 7 and 8. An application 900 for displaying an object three-dimensionally is described with reference to FIG. 9A.

FIG. 9A illustrates a music listening application where an album cover image object is displayed according to an embodiment of the present disclosure.

Referring to FIG. 9A, five album cover images 910a, 920a, 930a, 940a, and 950a are displayed on the music listening application 900. The third album cover image 930a is located the closest to a user, and the first album cover image 910a and the fifth album cover image 950a are aligned the farthest from a user. Then, the second album cover image 920a and the fourth album cover image 940a at both sides of the third album cover image 930a are behind the third album cover image 930a and are in front of the first album cover image 910a and the fifth album cover image 950a.

FIG. 9B illustrates a virtual space coordinate configuration applied to an album cover image object of FIG. 9A according to an embodiment of the present disclosure. An axis horizontal to a user (and the ground) is referred to as an X-axis, an axis vertical to a user (and the ground) is referred to as a Y-axis, and the front of a user is referred to as a Z-axis.

The virtual space coordinates of a sound source corresponding to the first album cover image 930a positioned at the center of the music listening application 900, which is located the closest to a user in FIG. 9A, may be a third position 930b. Additionally, the virtual space coordinates of sound sources that respectively correspond to the first album cover image 910a and the fifth album cover image 950a disposed at both ends of the music listening application 900, which are located the farthest from the user in FIG. 9A, may be a first position 910b and a fifth position 950b, respectively. Lastly, the virtual space coordinates of sound sources that respectively correspond to the second album cover image 920a and the fourth album cover image 940a disposed between the third album cover image 930a, the first album cover image 910a, and the fifth album cover image 950a may be a second position 930b and a fourth position 940b, respectively.

The electronic device 400 may apply a sound effect for differentiating the playback size of a sound source based on a Z-axis distance from a user. Accordingly, the playback size of a sound source at the third position 930b that is the closest to the user may be the largest and the playback sizes of sound sources at the first position 910b and the fifth position 950b that are the farthest from the user may be the smallest. The playback sizes of sound sources at the second position 920b and the fourth position 940b between the third position 930b, the first position 910b, and the fifth position 950b may be smaller than the playback size of a sound source at the third position 930b, and may be larger than the playback sizes of sound sources at the first position 910b and the fifth position 950b.

The electronic device 400 may mix the sound source of each of the first position 910b to the fifth position 950b and provide the mixed sound source to a user. According to an embodiment of the present disclosure, the electronic device 400 may provide only part of the five sound sources to the user. For example, the electronic device 400 may not provide to the user a sound source beyond a preset distance from the user on a virtual space.

Although it is described above that the electronic device 400 plays at least a plurality of sound sources, according to an embodiment of the present disclosure, the electronic device 400 may provide only a sound source for an album cover image disposed at the center among album cover images displayed on the music listening application 900 of FIG. 9A.

The sound source of each album image cover shown in FIG. 9A, for example, may be at least some sections of a track listed on a corresponding album. When an album image cover shown in FIG. 9A is displayed as an image for representing a specific track, the sound source may be at least some sections of the specific track. If an album image cover shown in FIG. 9A is displayed as an image for representing the album itself, the sound source may be at least some sections of the title track. The section may be the prelude, bridge, postlude, or climax of the track.

FIG. 9C illustrates an operation for applying a user input received from a user on a music listening application where an album cover image object is displayed according to an embodiment of the present disclosure.

The electronic device 400 may receive a user input for moving the third album cover image 930a disposed at the center of the music listening application 900 in FIG. 9A to the left. Accordingly, the fourth album cover image 940a may be moved to the center of the music listening application 900, and located the closest to the user. Additionally, a part of the first album cover image 910a may become invisible on the execution screen of the music listening application 900 by the user input, and the sixth album cover image where only a part is visible may become completely visible.

FIG. 9D illustrates a virtual space coordinate configuration applied to an album cover image object based on a user input in FIG. 9C according to an embodiment of the present disclosure. Similarly to FIG. 9B, the virtual space coordinates of a sound source corresponding to the fourth album cover image 940a positioned the closest to the user in FIG. 9C may be the third position 930b. Additionally, the virtual space coordinates of sound sources that respectively correspond to the second album cover image 920a and the sixth album cover image 960a disposed far from the user may be the first position 910b and the fifth position 950b, respectively. The virtual space coordinates of sound sources that respectively correspond to the remaining third album cover image 930a and fifth album cover image 950a may be the second position 920b and the fourth position 940b, respectively.

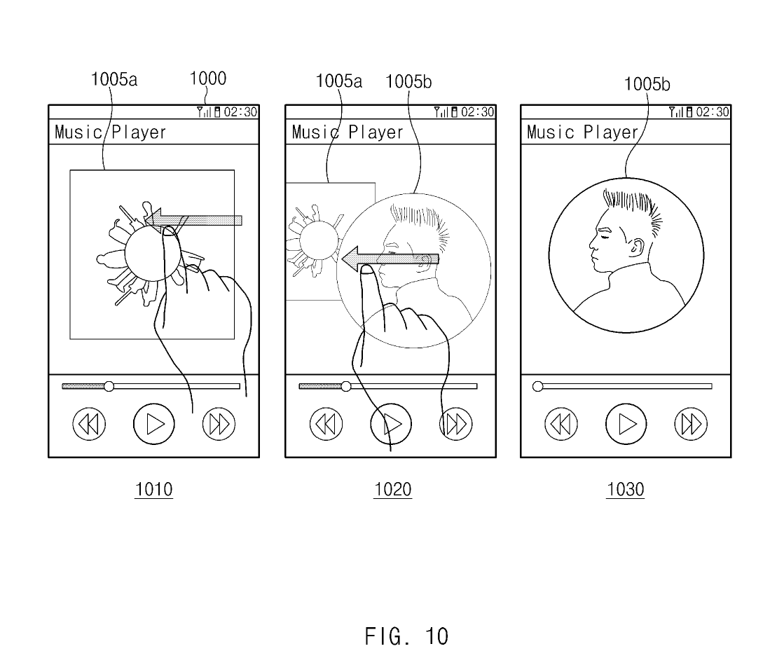

FIG. 10 illustrates a music listening application where an album cover image object is displayed according to another embodiment of the present disclosure.

Referring to the first step 1010 of FIG. 10, the electronic device 400 plays a track corresponding to a first album cover image 1005a shown on a music listening application 1000, through the music listening application 1000. Additionally, the electronic device 400 may currently receive a user input for dragging (or swiping) from the right of the music listening application 1000 to the center, from a user.

In the second step 1020, the electronic device 400 may display a second album cover image 1005b on the music listening application 1000 based on a user input being received in the first step 1010. Based on the user input, the second album cover image 1005b may be moved from the right of the music listening application 1000 to the right.

The electronic device 400 may apply a sound effect as if a position where a track corresponding to the first album cover image 1005a being played in the first step 1010 is played was moved to the left based on the user input. Additionally, the electronic device 400 may apply a sound effect as if a position where a track corresponding to the second album cover image 1005b is played was moved to the left. A track corresponding to the first album cover image 1005a and a track corresponding to the second album cover image 1005b may be mixed together and played.

In this case, a sound effect that the track corresponding to the first album cover image 1005a is faded out and the track corresponding to the second album cover image 1005b is faded in may be applied.

As the user input is touch-released, the second step 1020 may proceed to the third step 1030.

In the third step 1030, the electronic device 400 may allow a track corresponding to the second album cover image 1005b to be played based on the touch release of the user input. Referring to the third step 1030, a timeline as if the electronic device 400 played a track corresponding to the second album cover image 1005b from the beginning. According to an embodiment of the present disclosure, the electronic device 400 may reproduce a track corresponding to the second album cover image 1005b from a time point after being played in the second step 1020.

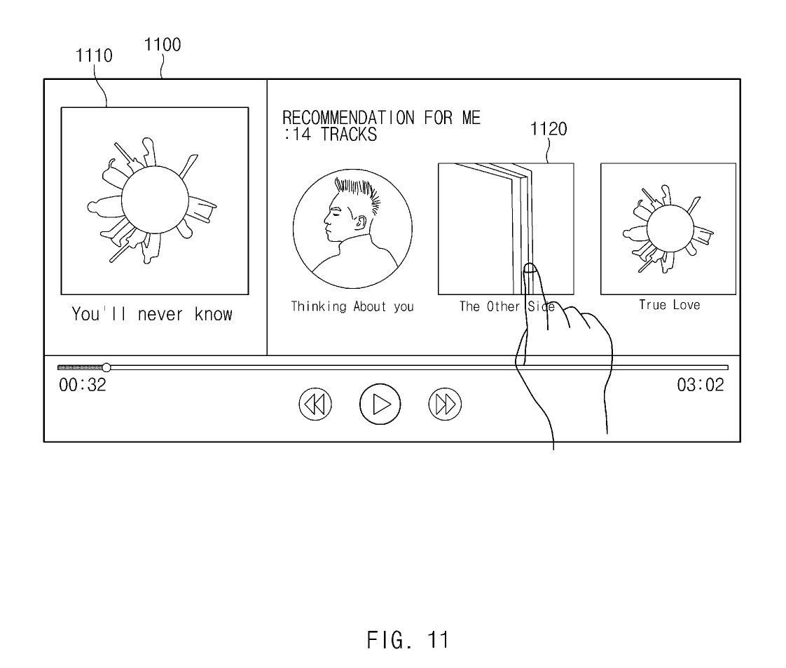

FIG. 11 illustrates a music listening application where an album cover image object is displayed according to another embodiment of the present disclosure.

Referring to FIG. 11, the first album cover image 1110 of an album where a track being played is listed may be displayed at an upper end left of the music listening application 1100, album cover images where recommendation tracks are listed may be displayed at a right upper end of the music listening application 1100, and a timeline of a track being played may be displayed at a lower end of the music listening application 1100.

The electronic device 400 may reproduce a track corresponding to the first album cover image 1110 through the music listening application 1100. According to an embodiment of the present disclosure, the electronic device 400 may set a sound effect as if a track corresponding to the first album cover image 1110 was heard at the front of a user.

The electronic device 400 may apply various embodiments of the present disclosure to an area at a right upper end of the music listening application 1100 where album cover images where recommendation tracks are listed are displayed.

For example, while a track corresponding to the first album cover image 1110 is played, the electronic device 400 may receive a user input for the second album cover image 1120. The electronic device 400 may mix a track corresponding to the first album cover image 1005a and a track corresponding to the second album cover image 1005b together and reproduce the mixed track. In this case, since the second album cover image 1120 is located at the center of a right upper end of the music listening application 1100, virtual space coordinates where a track corresponding to the second album cover image 1120 is played may correspond to the user's front. If the third album cover image at the right of the second album cover image 1120 is selected, an electronic device may convert virtual space coordinates where a corresponding track is played into the user's right.

Additionally, when a user input for selecting the second album cover image 1120 is dragged to the left/right at a right upper end of the music listening application 1100, as an object is moved as shown in FIGS. 9 and 10, a sound effect may be updated.

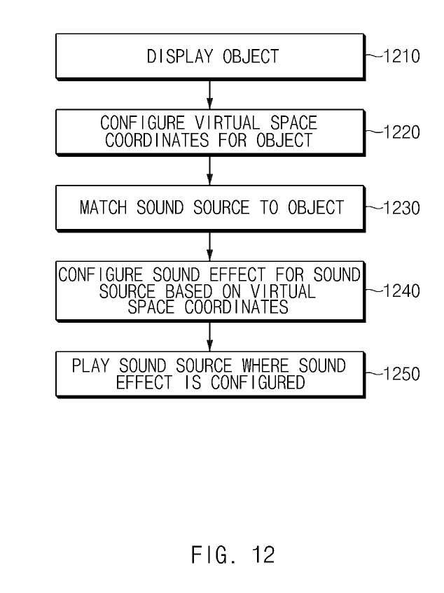

FIG. 12 is a flowchart illustrating a method for providing a sound UI in an electronic device (for example, the electronic device 100 or the electronic device 400) according to an embodiment of the present disclosure. A method of an electronic device shown in FIG. 12 to provide a sound UI may be performed by the electronic device described with reference to FIGS. 1 to 11. Accordingly, in relation to content not mentioned with reference to FIG. 12, an operation performed by the electronic device described with reference to FIGS. 1 to 11 may be applied to the method of the electronic device of FIG. 12 to provide the sound UI.

In operation 1210, the electronic device displays an object on an application. The object may be differently configured according to the application executed.

In operation 1220, the electronic device generates virtual space coordinates for the object displayed in operation 1210. The virtual space coordinates may be a virtual space that surrounds a user of the electronic device.

In operation 1230, the electronic device matches a sound source to the object displayed in operation 1210. The sound source may be differently configured by each object.

In operation 1240, the electronic device sets a sound effect for the sound source matched in operation 1230 based on the virtual space coordinates configured in operation 1220.

In operation 1250, the electronic device reproduces the sound source having the sound effect configured in operation 1240. The played sound source may allow a user to feel as if it is played at the virtual space coordinates converted in operation 1220.

According to an embodiment of the present disclosure, the order of operation 1220 and operation 1230 may be changed.

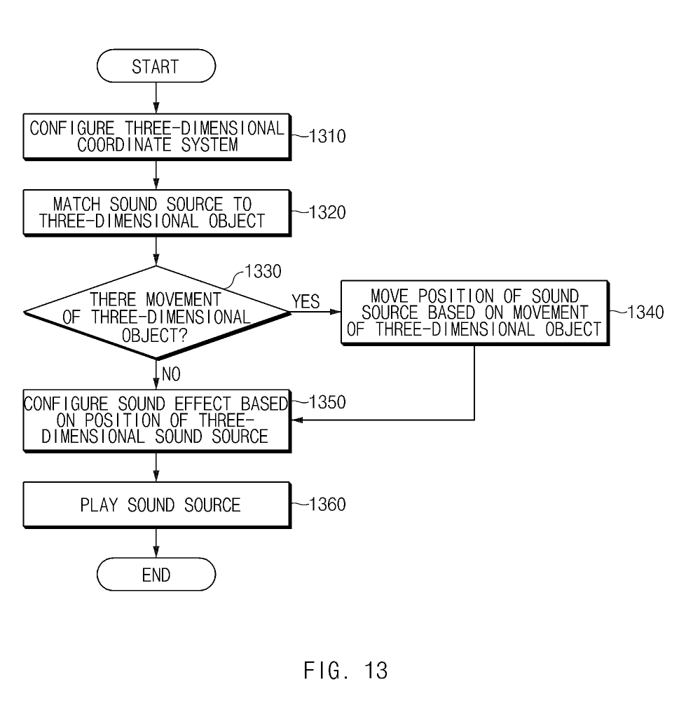

FIG. 13 is a flowchart illustrating a method for providing a sound UI in correspondence to a three-dimensional object in an electronic device (for example, the electronic device 100 or the electronic device 400) according to an embodiment of the present disclosure. A method of an electronic device shown in FIG. 13 to provide a sound UI in correspondence to a three-dimensional object may be performed by the electronic device described with reference to FIGS. 1 to 11. Accordingly, in relation to content not mentioned with reference to FIG. 13, an operation performed by the electronic device described with reference to FIGS. 1 to 11 may be applied to the method of the electronic device of FIG. 13 to provide the sound UI in correspondence to a three-dimensional object.

In operation 1310, the electronic device configures a three-dimensional coordinate system. The three-dimensional coordinate system may match a space on an application executed in an electronic device into a virtual space that surrounds a user of the electronic device.

In operation 1320, the electronic device matches a sound source into a three-dimensional object displayed on the application.

In operation 1330, the electronic device determines whether there is a movement of the three-dimensional object. The three-dimensional object may be moved through a user input, but the three-dimensional object may be moved without a user input. For example, the three-dimensional object may be moved as it is configured according to a condition preset by the application.

If there is a movement of the three-dimensional object, operation 1330 proceeds to operation 1340, and if not, operation 1330 proceeds to operation 1350.

In operation 1340, the electronic device moves the position of the sound source on the virtual space based on the movement of the three-dimensional object.

In operation 1350, the electronic device configures a sound effect based on the position of the three-dimensional sound source.

In operation 1360, the electronic device reproduces the sound source where the sound effect is configured.

According to an embodiment of the present disclosure, the electronic device and method allows a user to receive an auditory UI in addition to a visual UI by providing a sound UI to the user to feel as if a sound source was played at a specific position in correspondence to the position of an object displayed on a screen.

The term “module” as used herein may represent, for example, a unit including one of hardware, software and firmware or a combination thereof. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

At least a part of devices (e.g., modules or functions thereof) or methods (e.g., operations) according to various embodiments of the present disclosure may be implemented as instructions stored in a computer-readable storage medium in the form of a program module. In the case where the instructions are performed by a processor (e.g., the processor 120), the processor may perform functions corresponding to the instructions. The computer-readable storage medium may be, for example, the memory 130.

A computer-readable recording medium may include a hard disk, a floppy disk, a magnetic medium (e.g., a magnetic tape), an optical medium (e.g., CD-ROM, digital versatile disc (DVD)), a magneto-optical medium (e.g., a floptical disk), or a hardware device (e.g., a ROM, a RAM, a flash memory, and the like). The program instructions may include machine language codes generated by compilers and high-level language codes that may be executed by computers using interpreters. The above-mentioned hardware device may be configured to be operated as one or more software modules for performing operations of various embodiments of the present disclosure and vice versa.

For example, an electronic device may include a processor and a memory for storing computer-readable instructions. The memory may include instructions for performing the above-mentioned various methods or functions when executed by the processor.

A module or a program module according to various embodiments of the present disclosure may include at least one of the above-mentioned elements, or some elements may be omitted or other additional elements may be added. Operations performed by the module, the program module or other elements according to various embodiments of the present disclosure may be performed in a sequential, parallel, iterative or heuristic way. Furthermore, some operations may be performed in another order or may be omitted, or other operations may be added.

While the present disclosure has been shown and described with reference to certain embodiments thereof, it will be understood by those skilled in the art that various changes in form and details may be made therein without departing from the scope of the present disclosure. Therefore, the scope of the present disclosure should not be defined as being limited to the embodiments, but should be defined by the appended claims and equivalents thereof.

What is claimed is:

1. An electronic device comprising:
a display circuit configured to display at least one object;
an audio circuit configured to reproduce sound; and
a processor electrically connected to the display circuit and the audio circuit,
wherein the processor is configured to:
generate virtual space coordinates for the at least one object;
match a sound source to the at least one object;
set a sound effect for the sound source based on the virtual space coordinates; and
reproduce the sound source using the set sound effect.

2. The electronic device of claim 1, wherein the sound effect is set to be recognized as if the sound source was played at the virtual space coordinates.

3. The electronic device of claim 2, wherein the virtual space coordinates are coordinates corresponding to a space that surrounds the electronic device.

4. The electronic device of claim 1, further comprising a user input circuit configured to receive a user input for the object, wherein the processor is further configured to reproduce a sound source corresponding to the object based on a user input for selecting the object.

5. The electronic device of claim 4, wherein the user input comprises at least one of a voice input, a gesture input, an electronic pen input, or a touch input.

6. The electronic device of claim 4, wherein the user input circuit receives a user input for moving the object, and
wherein the processor is configured to change the virtual space coordinates corresponding to the object along a traveling path of the object, and update the sound effect based on the changed virtual space coordinates.

7. The electronic device of claim 4, wherein the user input circuit receives a drag input for sequentially selecting a plurality of objects, and wherein the processor is further configured to sequentially reproduce a plurality of sound sources that respectively correspond to the plurality of objects.

8. The electronic device of claim 1, wherein when the object is a cover image of a music album, the sound source comprises an intro or a climax of a music track included in the music album.

9. The electronic device of claim 1, wherein when there is a plurality of objects, the processor is further configured to mix at least two among a plurality of respective sound sources for the plurality of objects.

10. The electronic device of claim 1, further comprising a sensor circuit configured to recognize a user's gaze, wherein the processor is further configured to determine virtual space coordinates for the object based on a direction of the user's gaze.

11. The electronic device of claim 2, further comprising a sensor circuit configured to recognize a user's movement, wherein the processor is further configured to update the set sound effect to maintain the virtual space coordinates with respect to the user based on the user's movement.

12. A method of an electronic device comprising:
displaying an object;
generating virtual space coordinates for the object;
matching a sound source to the object;
setting a sound effect for the sound source based on the virtual space coordinates; and
reproducing the sound source using the set sound effect.

13. The method of claim 12, further comprising:
receiving a user input for moving the object;
changing the virtual space coordinates corresponding to the object along a traveling path of the object; and
updating the sound effect based on the changed virtual space coordinates.

14. The method of claim 12, further comprising:
receiving a user input for moving the object;
moving the object and another object together based on the user input for moving the object; and
reproducing a sound source corresponding to the other object mixed with a sound source corresponding to the object.

15. The method of claim 12, further comprising receiving a drag input for sequentially selecting a plurality of objects, wherein reproducing the sound source comprises sequentially playing a plurality of sound sources that respectively correspond to the plurality of objects.

16. The method of claim 12, further comprising recognizing a user's gaze, wherein generating the virtual space coordinates for the object is performed based on a direction of the user's gaze.

17. An electronic device comprising:
a memory configured to store a plurality of specified positions, wherein an object corresponding to a sound source is displayed on a display functionally connected to the electronic device, wherein the plurality of specified positions comprise a first specified position and a second specified position; and
at least one processor,
wherein the at least one processor is configured to display the first specified position and the second specified position in relation to the object on the display,
receive an input relating to the object, and
move the object from the first specified position to the second specified position in response to the input, and output the sound source with a changed sound effect of the sound source based on a traveling distance or a direction of the object from the first specified position to a point between the first specified position and the second specified position.

18. The electronic device of claim 17, wherein when there are a plurality of objects that share the plurality of specified positions, the at least one processor is further configured to change a sound effect for sound sources that respectively correspond to the plurality of objects based on a movement of each of the plurality of objects, and mix and output the sound sources that respectively correspond to the plurality of objects.

19. The electronic device of claim 17, wherein the at least one processor is further configured to select at least some objects among the plurality of objects, and mix and output sound sources corresponding to the selected objects.

20. The electronic device of claim 18, wherein the mixing of the sound sources is configured to separate a left channel and a right channel of each of the sound sources to change a sound effect, and merge and output the left channel and the right channel.
